(19) United States
(12) Patent Application Publication
(10) Pub. No.: US 2026/0247010 A1
(43) Pub. Date: Aug. 20, 2026

(54) COMPOSITED ADVERTISING IN HOSPITALITY ENVIRONMENTS

(71) Applicant: Sonifi Solutions, Inc., Sioux Falls, SD (US)

(72) Inventors: Derin Michael Zerr, Kahului, HI (US); Ahmad Ouri, Sioux Falls, SD (US)

(73) Assignee: Sonifi Solutions, Inc., Sioux Falls, SD (US)

(21) Appl. No.: 19/545,291

(22) Filed: Feb. 20, 2026

Related U.S. Application Data
(60) Provisional application No. 63/760,845, filed on Feb. 20, 2025.

(51) Int. Cl. H04N 21/81; H04N 21/431

(52) U.S. Cl. CPC H04N 21/812; H04N 21/4316

(57) ABSTRACT

A system includes a processor and memory including instructions, that when executed by the processor, cause the processor to detect a trigger event associated with a display being viewed by a guest within a property, generate, in response to the detecting the trigger event, ad content based on information about the guest that is available to the property, and render the ad content to the display.

### FIELD

Example embodiments are generally directed to composited advertising, such as in hotels, hospitals, and like.

### BACKGROUND

Hospitality environments often include centrally controlled entertainment systems to provide broadcast and on-demand television services for guests.

### BRIEF DESCRIPTION OF THE FIGURES

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 illustrates a system according to at least one example embodiment.

FIG. 2 illustrates an environment for the system in FIG. 1 according to at least one example embodiment.

FIG. 3 illustrates a diagram for the system in FIG. 1 according to at least one example embodiment.

FIG. 4 illustrates a method for presenting customized ad content according to at least one example embodiment system according to at least one example embodiment.

FIG. 5 illustrates graphics to show how ad content may be added to existing content according to at least one example embodiment.

FIG. 6 illustrates additional graphics to show how ad content may be added to existing content according to at least one example embodiment.

### DETAILED DESCRIPTION

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device.

In one or more examples, the described methods, processes, and techniques may be implemented in hardware, software, firmware, or any combination thereof. If implemented in software, the functions may be stored as one or more instructions or code on a computer-readable medium and executed by a hardware-based processing unit. Alternatively or additionally, functions may be implemented using machine learning models, neural networks, artificial neural networks, or combinations thereof (alone or in combination with instructions). Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10X Fusion processors; Apple A11, A12, A12X, A12Z, or A13 Bionic processors; or any other general purpose microprocessors), graphics processing units (e.g., Nvidia GeForce RTX 2000-series processors, Nvidia GeForce RTX 3000-series processors, AMD Radeon RX 5000-series processors, AMD Radeon RX 6000-series processors, or any other graphics processing units), application specific integrated circuits (ASICs), field programmable gate arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

Example embodiments may be shown and described with respect to sending messages between elements of the systems here. It should be appreciated that the term “message” as used herein generally includes one or more electrical signals traveling over a wired network (e.g., coax, optical, and/or the like) and/or one or more electromagnetic signals traveling over a wireless network (e.g., Wi-Fi).

Inventive concepts relate to advertising within a hospitality property, such as a hotel or hospital. Related art advertising within such a property involves presenting pre-made and inflexible video, graphic, and/or audio ads which are not personalized to the viewing guest or guests. The present disclosure addresses the shortcomings of the related art advertising methods by leveraging sources of data available to the property about a particular guest to create dynamic ads for groups of guests or even individual guests. More specifically, hospitality entertainment providers and the properties in which the entertainment providers operate their systems have access to data sources that can be leveraged to create dynamically composited advertising and present customized ads to a guest. The present disclosure proposes to manipulate what is displayed to a guest at any given moment using a guest's mobile device, set top box (STB), or smart TV in the guest room using information that provides knowledge of who that guest is in the room. Such information may be collected from multiple sources, such as property management systems (PMSs), reservation systems, loyalty programs, content management systems, and/or any other source which contains information about a guest that is accessible to the entertainment provider and/or property such that ad content provided to each guest is customizable. As will be explained in more detail below, there are a variety of triggers for when and where to display advertising, which allows for tremendous flexibility.

The above-mentioned advertising customization may occur through compositing existing video from a video source with a dynamic graphic layer as the video plays on a display in the guest room or on the guest's mobile device. The video and dynamic graphic layer may be customized based on guest information and/or guest behavior. Example embodiments enable the entertainment provider to insert guest-customized advertising into various content, such as Free to Guest (FTG) linear channels (e.g., traditional off air, satellite, or cable channels that are broadcast to the room), on-demand videos (e.g., videos started on demand and streamed/broadcast to a guest from a local server or cloud server), and streaming provider videos (e.g., videos from Internet-based streaming services that are streamed/broadcast to a property or individual guest, free ad-supported streaming TV (FAST) content). In some examples, the customized ad content takes the form of inserted video, such as video inserted into a traditional broadcast video or streamed video that overrides the original video content. In one examples, the customized ad content may be scheduled to play on specific devices, channels, or in the navigation interface of a TV.

As discussed in more detail below, using a combination of on site or cloud server processing and the display capabilities of the TV/STB, the graphics used for compositing with video can take many forms including:
1) Static images, such as pre-made images with no dynamically created assets. These static images can be scheduled and distributed to any hotel system offering a library of static image assets for combining with video. The appropriate image can be selected based on criteria from the entertainment provider's integrations.
2) Augmented images, such as pre-made images with some components added dynamically. The base image can be scheduled and disturbed to any hotel system. When the image is composited with video, some region of the resulting video can be altered with customized content generated on the fly. An example of this would be a hotel brand logo embedded on a background image and when composited, the hotel site name, address, or phone number is dynamically added to the graphic.
3) Dynamically generated images, such as images created completely dynamically based on suitable criteria from the entertainment provider's integrations. These dynamically created images could be generated by an on-property server, cloud instance, AI engine, or by the TV/STB display engine. An example of dynamically created ad content would be a frame around video that contains a dynamically generated background color/image and a QR code with room or guest specific information for dining reservations.

Using the entertainment provider's ability to access different data sources related to hospitality, the level of customization for composited advertising could vary depending on what was required. With access to integrations, such as content management systems, property management systems, loyalty systems, reservation systems, guest preference records, etc. it is possible to create different tiers of targeted advertising that could be made available to properties. Example tiers of advertising include:
1) No customization-ads and videos play as originally produced without modification.
2) Brand level customization-ads and videos are composited with graphics based on a particular brand. These ads may appear the same across each hotel of a specific brand.
3) Management/owner level customization-ads and videos are composited with graphics based on who owns or manages the hotel the ads are playing in.
4) Hotel level customization-ads and videos are composited with graphics based on a particular hotel. This could be customized to be a single hotel or multiple hotels depending on what is desired. This could be driven by site lists, geolocation, random selection, etc. depending on what the desired distribution is.
5) Group level customization-using the data from the available integration systems, the composited content could be customized to a group of guests within a single hotel or multiple hotels. One example would be identifying all convention attendees across multiple hotels and displaying custom ad content to only them. Another use of this would be providing specific content or composited content to wedding parties or other event participants.
6) Individual level customization-using a combination of the data available to the entertainment provider and/or the property, an individual or hotel room is targeted to receive unique dynamic ad content. This enables each composited piece of content to be customized for that guest's demographic information, hotel stay habits, loyalty program level, home geolocation, etc. In some examples, the customization is based on TV navigation behaviors during a guest's stay by analyzing channel changes, networks watched, time duration of each view, what on demand videos were viewed, what services they used from the interactive interface, and/or the like.

Customizing ad content as proposed herein may be implemented with one or video combining techniques. Combining existing video with a dynamically generated graphic allows the two content types to appear as a single video to the guest. This can be done as a solid and/or semi-transparent graphic overlay on top of the existing video or by scaling the existing video and placing the dynamically generated graphic layer as a frame around two or more sides of the existing video content. Both techniques keep the existing video aspect ratio consistent with the original format size rather than needing to stretch the existing video along one of its axes, thereby distorting the existing video and potentially consuming additional processing resources.

The entertainment provider for a property often controls most or all of the TV experience for guests, which enables the use of various triggers to start playing an ad or video content as well as various options for where to place the ad content. Options for ad content placement include:
1) Interactive placement-guest selects an icon/item from the interactive menu representing the ad to start video content.
2) Interactive entry-video automatically plays when a guest enters the interactive menu or selects an interactive service icon. After video plays, the guest is taken to their desired interactive service destination. This could be scheduled to occur on the first entry into the interactive, every entry, first entry each day, etc. to allow for the most flexibility.
3) TV turn on-video plays when a guest turns on their TV before tuning to a FTG channel or launching an interactive menu. This could be scheduled to occur on first turn on during a stay, every turn on, first turn on each day, etc. to allow for the most flexibility.
4) Ad insertion into existing video content
   a. FTG ad insertion-replace local ad spots with assigned composted video/graphic content.
   b. VOD stream insertion (pre-roll, post-roll, timed locations during video, etc.)
5) Video insertion into channel lineup
   c. Via an interactive program guide (IPG), add non-linear “ad channels” that stream when selected. These ad channels could be started at the beginning of a video sequence or an artificial time location into a playlist to give the feeling that the guest is viewing an actual channel.
   d. Start on-demand ad video before tuning to a requested channel either from the IPG or between channel tunes. This appears to be an ad on the requested channel to the guest.
   e. Between channel tunes-insert on-demand ad video between actual FTG channels. An example would be performing a channel up from channel 4, and then starting a composited ad stream on a virtual channel, guest would channel up off composited ad stream to channel 5. This would appear to be another channel to the guest.
6) Combining ad content with an existing channel or streaming video:
   f. Use the scaling, framing, and overlay options to augment an existing video/channel.
   g. The framing could be triggered by any suitable criteria, such as:
      i. Channel changes
      ii. Tuning to a particular channel(s)
      iii. Length of time on a channel
      iv. On demand content started, finished, time marker, etc.
      v. Powering on/off the TV/STB
      vi. Exiting the interactive system to a FTG channel
      vii. Any other TV events that are available to the entertainment provider's software could be used as a trigger

In the overlay examples, the graphic could also be a solid image designed to replace a particular area of video to customize the presentation for a particular hotel, group, guest, or other criteria available to the property or entertainment provider for determining what custom content a guest will see. This would allow a video that is created for many distribution channels to become customized down to an individual hotel guest level without the expense of producing and streaming/broadcasting that video individually. An example would be compositing dynamic graphics over advertisements to create an ad that can be traced back to an individual hotel guest. In this example, the generic ad that may be broadcast everywhere would have ordering information that everyone (including off-property viewers) would use to order the advertised item. Example embodiments would overlay an image when that generic ad was played within a guestroom to make the fulfillment information specific to the room and/or guest.

The different data and presentation options described herein can be combined to give a unique ad experience to hospitality guests. By leveraging different levels of guest knowledge combined with the technical capabilities available, a property's ad approach can be tailored to the guest and/or the property, which may drive revenue and increase guest satisfaction. These and other aspects of the present disclosure are described in more detail below with reference to the figures.

Here, it should be appreciated that the terms “guest” used herein is intended to cover individuals who are officially registered as a guest of a hotel or a patient of hospital as well as individuals that are not officially registered guests or patients but who are located within the property 200 and using the property's resources. The term “entertainment provider” as used herein should be understood to include the entity which exerts control over in-property networks that connect guests to various entertainment options and/or the Internet. An entertainment provider may cooperate with owners or managers of properties 200 to provide such entertainment options.

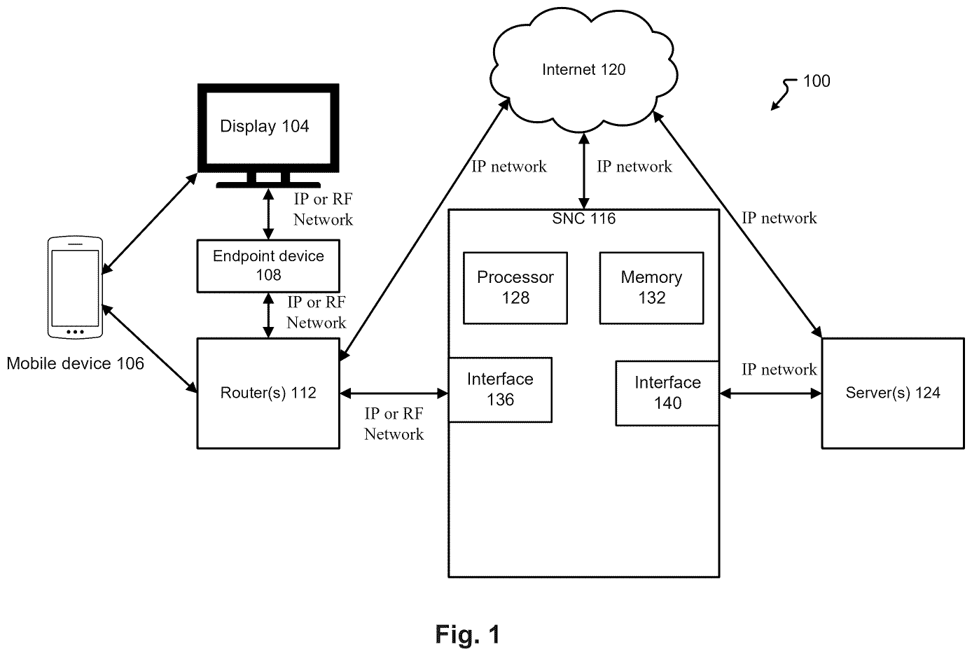

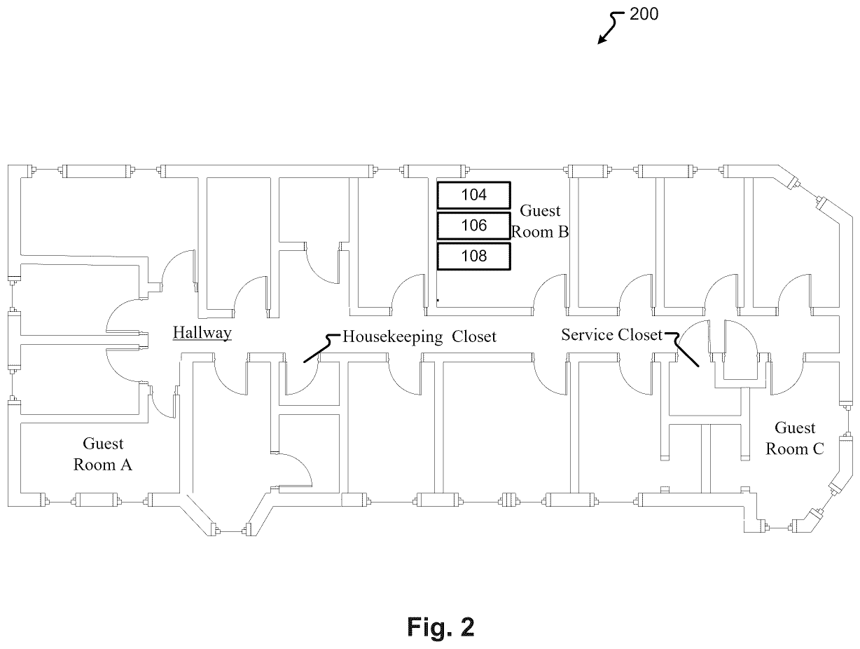

FIG. 1 illustrates a system 100 in which customized advertising may be deployed according to at least one example embodiment. The system 100 includes a display 104, a mobile device 106, an endpoint device 108, one or more routers 112, a system network controller (SNC) 116, the Internet 120, and one or more servers 12. Elements of the system 100 may provide entertainment services to an environment or property 200 illustrated in FIG. 2. The property 200 may correspond to a managed facility where an entertainment provider has access to guest/tenant information by way of the guest or tenant inhabiting the property 200. Non-limiting examples of a property 200 include a dormitory, a time share, a condo, an apartment, a complex with multi-dwelling units (MDUs), an assisted-living facility, a hotel, a motel, an inn, and a healthcare facility (acute care hospital, clinic, hospice etc.). FIG. 2 illustrates an example that includes a plurality of guest or patient rooms A, B, C, etc. and other service related rooms. In this scenario, each guestroom in the property 200 may include a display 104, a mobile device 106 operable by a guest, and an endpoint device 108, as shown for guest room B, for example. A guestroom may further comprise a router 112 in some embodiments. In at least one embodiment, on-site routers 112 are located in service closets or other areas of the property 200 not easily accessible to guests.

A display 104 may comprise suitable hardware, software, and processing capability for reproducing audio and/or video content for consumption by a guest. For example, a display 104 may be implemented by a television (LED, LCD, etc.), a computer monitor, a tablet, a projector, and/or other device suitable for reproducing audio and/or video content. In some examples, the display 104 is a smart TV that has IP communication capabilities to communicate with other elements of the system 104. In other examples, the display 104 utilizes the endpoint device 108 to communicate with other elements of system 104.

The mobile device 106 may correspond to a guest device that has computing and storage capabilities and that is generally mobile in nature. Accordingly, the mobile device 106 may be implemented with a smartphone, a laptop, a tablet, and/or the like.

The endpoint device 108 may comprise suitable hardware, software, and processing capability for providing a communications interface between a router 112 and the display 104. An example of an endpoint device 108 includes a broadcast local area network (b-LAN) terminal connected to the display 104 and to translate signals routed between the display 104 and the router 112. In another embodiment, the endpoint device 108 may comprise an Internet Protocol (IP) client that translates signals routed between the display 104 and a router 112. The endpoint device 108 may be integrated with the display 104 or exist as separate device.

The one or more routers 112 may comprise suitable hardware, software, and processing capability for providing communication between the mobile device 106, the endpoint device 108, the internet 120, and/or the SNC 116. A router 112 may be wireless in nature (e.g., a Wi-Fi router) and enable wireless communication between elements of the system 100. Additionally or alternatively, a router 112 may enable wired communication between elements of the system 100 (e.g., a router 112 may comprise an RF router for routing signals encoded with frequency-shift keying (FSK) techniques, a router 112 may comprise a network switch, such as an Ethernet switch, and/or the like). One or more routers may exist within the property 200 while one or more other routers are remote to the property 200 to communicate signals over long distances.

The SNC 116 may include suitable hardware, software, and processing capability for controlling various functions within the system 100. For example, the SNC 116 may include suitable processing circuitry, such as a processor 128 and a memory 132 including instructions that are executable by the processor 128 to carry out the various methods described herein. The memory 132 may correspond to any suitable type of memory device or collection of memory devices configured to store instructions. Non-limiting examples of suitable memory devices that may be used include flash memory, Random Access Memory (RAM), Read Only Memory (ROM), variants thereof, combinations thereof, or the like. In some embodiments, the memory 132 and processor 128 may be integrated into a common device (e.g., a microprocessor may include integrated memory). Additional or alternative suitable processing circuitry in the SNC 116 may include an application specific integrated circuit (ASIC), an Integrated Circuit (IC) chip, a Central Processing Unit (CPU), a Graphics Processing Unit (GPU), a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs. It should be appreciated that any appropriate type of electrical component or collection of electrical components may be suitable for inclusion in the processing circuitry 128.

The SNC 116 may further include communication interfaces 136 and 140 for enabling wired and/or wireless communication. The interface 136 may include suitable hardware or hardware and software for communicating with a network of the property 200 (which may be closed or private) while the interface 140 may include suitable hardware or hardware and software for communicating with a network outside the property 200 (e.g., the Internet). Although not explicitly shown, it should be appreciated that the other elements in FIG. 1 also include one or more communication interfaces for facilitating wired and/or wireless communication, internal or external to the property 200.

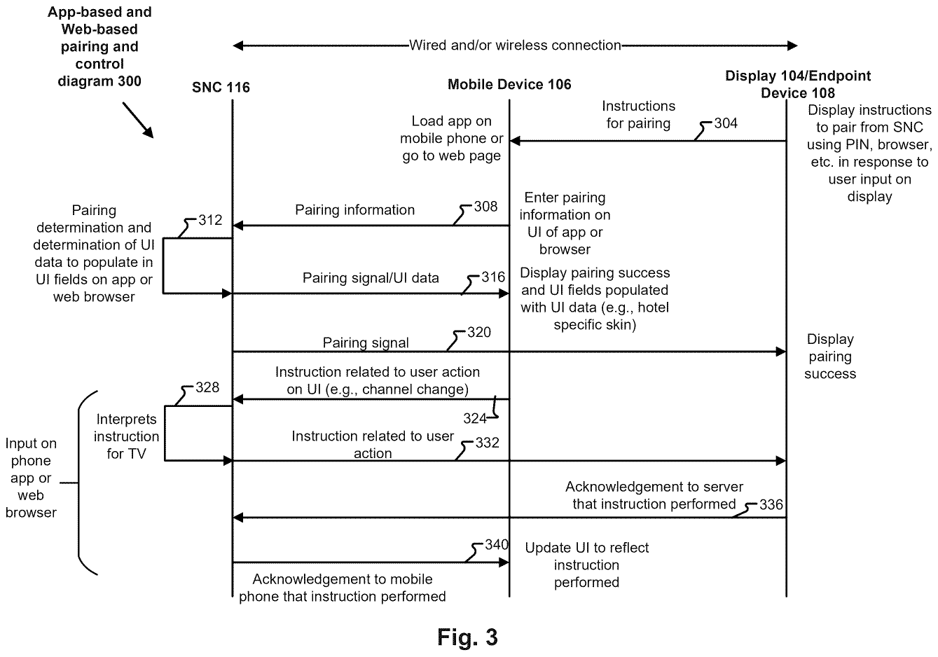

In at least one embodiment, the SNC 116 provides and controls access to entertainment options for guests within the system 100. Such entertainment options include but are not limited to viewing of live television programming, video on demand, room service, video games, and/or the like, all of which may be presented on a display 104. The SNC 116 can include or have access to content, such as stored movies, videos, menu screens, animations, audio content and the like. The SNC 116 may access content through a third party content provider (e.g., through a streaming application). The SNC 116 may be installed and/or controlled by the entertainment provider which enables the entertainment options and controls guest access to such options (see FIG. 3). As discussed in more detail below, an SNC 116 may control functions related to generating and incorporating dynamically generated and customized ad content into one or more of the entertainment options under control of the SNC 116 for consumption by guests within the property 200.

The one or more servers 124 may comprise suitable hardware, software, and processing capability for enabling various functions within the system 100. In one embodiment, the one or more servers 124 have the same or similar components as the SNC 116. For example, a server 124 may comprise an application server that runs and/or provides application data to an application on mobile device 106 that is associated with the same entity that controls the SNC 116. In an embodiment according to FIG. 3, such an application enables pairing of a mobile device 106 to the SNC 116 to enable the mobile device 106 with certain controls of the display 104. Further, the servers 124 may comprise a server operated by a content provider (e.g., NETFLIX) that provides end-guest audio and/or video content to the display 104. More or fewer servers 124 may be included depending on implementation of the system 100.

The system 100 may be deployed in various configurations. In general, a property 200 includes the display 104, an endpoint device 108, router(s) 112, and one or more mobile devices 106. The SNC 116, however, may be local or remote to the property 200. For example, in one configuration, the SNC 116 is deployed remotely from the property 200 so that the SNC 116 may remotely control multiple environments 200 from a single location (e.g., in accordance with suitable cloud computing technologies). Here, troubleshooting and maintenance of a remotely located SNC 116 can occur at the single, remote location of the SNC 116. In another configuration, the SNC 116 is deployed local to the property 200, such as within a service closet of the property 200 or some other suitable location near or on-site the property 200. In this case, an SNC 116 may be located at each one of multiple environments 200. In yet another example, an SNC 116 may have some components located local to the property 200 and some components located remote to the property 200. The above described configurations of the SNC 116 may also apply to the router(s) 112 and/or a server within the server(s) 124 depending on design of the system 100.

Communication between elements of the system 100 may also have various configurations. For example, the router(s) 112, SNC 116, and/or server(s) 124 may communicate with one another over a closed or private network that does not involve the Internet such as a LAN (local area network) or WAN (wide area network) connection. In other embodiments, the Internet 120 facilitates communication between the routers 112, SNC 116, and/or the server(s) 124. Here, it should be appreciated that communication between the Internet, the SNC 116, and the server(s) 124 is generally IP communication. Meanwhile, the SNC 116, routers 112, endpoint device 108, and display 104 may be under control of the property's 200 entertainment provider, and such communication between these elements may be entirely IP in nature, entirely RF in nature, or a blend of IP and RF. In some examples, the SNC 116 acts as an edge device for a property 200 which has the ability to manage (block, allow, modify) communications passing between the property 200 and the Internet 120.

It should be appreciated that the elements of the system 100 and property 200 are shown for the sake of explanation and that more or fewer elements may be included. In addition, one or more elements of the system 100 may be integrated with one or more other elements of the system 100. For example, the SNC 116 and an application server within server(s) 124 that is controlled by the same entity as the SNC 116 may be integrated with one another.

FIG. 3 illustrates a diagram 300 for the system 100 in FIG. 1 according to at least one example embodiment. Each operation in diagram 300 may be carried out with one or more suitable messages or signals sent over a wired and/or wireless connection.

As described herein, the system 100 is a multi-guest interactive system. In general, the system 100 is used in connection with the delivery of video and/or audio signals to televisions or other output devices in rooms of the property 200. The property 200 generally includes or is in communication with a host computer or server, such as the SNC 116, that performs various functions, including implementing and providing features and components related to entertainment. FIG. 3 illustrates various operations and/or messages exchanged to accomplish a pairing between an SNC 116 and a mobile device 106 which enables the guest of the mobile device 106 control functionality on the display 104. Although the pairing processes described with reference to FIG. 3 are not necessary to carry out customized ad generation concepts described herein, the pairing processes of FIG. 3 may prove useful for identifying a guest and collecting guest-specific information (e.g., channel viewing habits, menu-navigation history, etc.) which can be used to generate customized ad content.

The diagram 300 covers both application-based pairing and control through a mobile device application and web-based pairing and control through a uniform resource locator (URL) of a web browser. The below example scenario omits an explicit illustration of other elements of the system 100 for the sake of simple explanation, but one of ordinary skill in the art can appreciate the roles of these unillustrated elements. As shown, communication between elements may be over wireless and/or wired connections (e.g., CATV cable, Ethernet cable, Wi-Fi, etc.).

In operation 304, a display 104 displays instructions for pairing the mobile device 106 to the display 104 through the SNC 116. The instructions may be displayed in response to guest input through a remote control of the display 104. In this example, the instructions may include a series of steps that a guest of the mobile device 106 performs in order to complete the pairing process. For example, the instructions may direct the guest to download and open a specific mobile application on the mobile device 106 or to open a web browser and visit a specific URL. The instructions may further include directing the guest to enter a unique pairing code that is generated or assigned by the SNC 116 to identify an address or port to which the display 104 is connected. The pairing code may be sent to the display 104 from the SNC 116 in response to the guest input through a remote control of the display 104, and may be displayed. The communications between each element in the messaging diagram 300 may be encrypted as desired. Here it should be appreciated that pairing the mobile device 106 to the display 104 may include pairing the mobile device 106 to the display 104 itself, a set top box connected to the display 104, an endpoint device 108 connected to the display 104, and/or another suitable device in the guestroom that enables the mobile device 106 to control the display 104 or other device in the guestroom.

Other possible examples for the mobile device 106 obtaining the pairing code include scanning a bar code, QR code, or other machine readable code displayed by the display 104, or otherwise communicating the pairing code supplied by the SNC 116 to the mobile device 106. In one embodiment, the mobile device 106 may be paired with the guestroom upon the mobile device 106 connecting to a guest wireless (e.g., Wi-Fi) network. In this case, the guest internet system is alerted when the mobile device 106 connects to the network, determines that the mobile device 106 is associated with a particular guestroom through a property management system of the property 200 (e.g., with a last name and room number entered when connecting to the network), and then sends a notification to the SNC 116 that the mobile device 106 is authorized to control the display 104 and/or other devices in the guestroom.

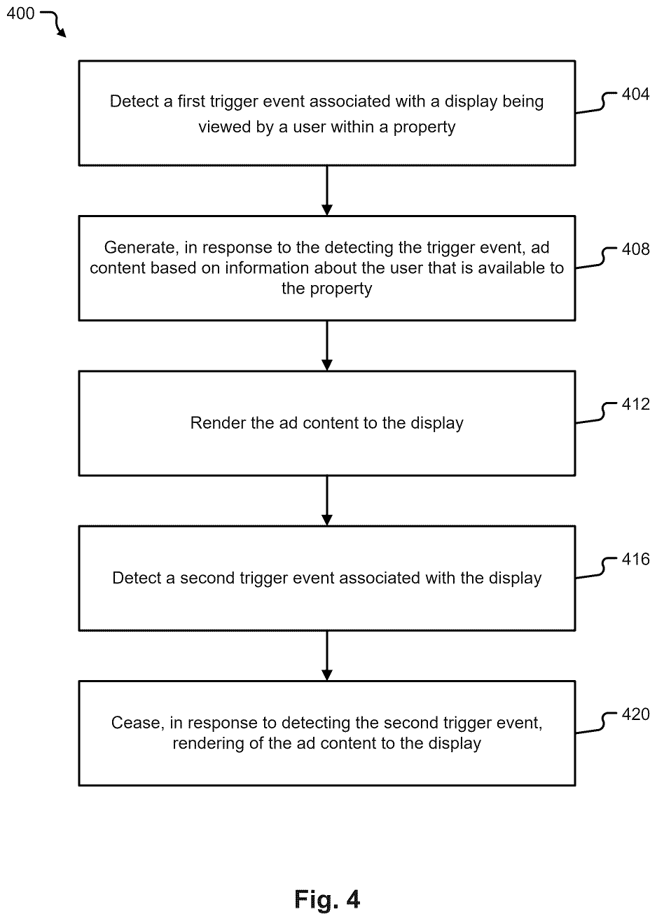

In operation 308, the mobile device 106 sends pairing information to the SNC 116. The pairing information includes the pairing code displayed on the display 104 in operation 304 and entered on the mobile device 106. Pairing information entered and sent in step 308 may include guest-specific information which can be used to generate customized ads according to concepts described herein. For example, the interface on which the guest enters the pairing code may also contain fields for the guest to input information described below with reference to FIG. 4, such as viewing preferences, activity preferences, existing plans during their stay, desired plans during their stay, dining preferences, and/or the like.

In operation 312, the SNC 116 makes a pairing determination and a determination of which guest interface (UI) data to populate in UI fields on the mobile device 106 using the pairing information. For example, the SNC 116 determines whether the pairing code received from the mobile device 106 matches a pairing code stored at or accessible by the SNC 116, and if a match exists, the SNC 116 stores (e.g., temporarily stores) an association between that particular mobile device 106 and the address or port identified by the pairing information from operation 308. This association indicates to the SNC 116 that signals from the mobile device 106 to control the display 104 and/or content provided to the display 104 should be routed to the address or port to which the display 104 is connected, and vice-versa. In addition, the SNC 116 may use the known address or port to which the pairing code was provided by the SNC 116 to identify the property at which the display 104 is located in order to determine the UI data that should populate UI fields of the application or web browser at the mobile device 106.

In operation 316, the SNC 116 sends a pairing signal to pair the mobile device 106 with the SNC 116 and to populate UI data in the appropriate UI fields on the mobile device 106. The UI of the mobile device 106 displays a notice that the pairing was a success and displays a UI with UI fields populated by the UI data determined in operation 312. For example, if the property is a hotel, the UI data populates the UI fields such that the mobile device 106 displays a hotel-specific skin (e.g., the hotel logo and other predetermined UI fields that the hotel would like populated). The UI of the application or web browser at the mobile device 106 may be preprogrammed to appear with certain default UI data in certain default UI fields prior to pairing, and then upon successful pairing, additional UI fields may be populated according to UI data included with the signal or message received in operation 316. That is, the mobile device 106 application or web browser may be preprogrammed with a number of possible preexisting UI fields, and the signal or message received by the mobile device 106 in operation 316 populates (or depopulates) a number of the possible preexisting UI fields so that the mobile device 106 displays a UI that is tailored to the property.

In operation 320, the SNC 116 sends the pairing signal or message to the address or port associated with the pairing, which causes the display 104 to display an indication of pairing success with the mobile device 106.

At this stage, the SNC 116 is ready to accept control signals from the mobile device 106 and to apply those signals in operations that can include controlling the content displayed by the display 104 and certain operating parameters of the display 104, such as the volume of audio output by the display 104. In addition, signals related to the playback of the content or other information can be provided from the SNC 116 to the mobile device 106.

Operations 324 to 340 relate to the system responding to guest input on mobile device 106 application or on a browser running on the guest mobile device.

In operation 324, the mobile device 106 sends an instruction related to guest action on the application or web browser at the mobile device 106. For example, the guest of the mobile device 106 activates the UI element on the application that indicates the guest desired to change a channel on the display 104.

In operation 328, the SNC 116 receives the instruction related to the guest action.

In operation 332, the SNC 116 sends an instruction to the display 104 that instructs the display 104 to respond in a manner consistent with the guest action on the application or web browser at the mobile device 106. The instruction may be received and interpreted by the endpoint device 108 which causes the display 104 to respond accordingly.

In operation 336, the display 104 sends an acknowledgement to the SNC 116 that the instruction received in operation 332 has been performed.

In operation 340, the SNC 116 sends an acknowledgement to the mobile device 106 that the display 104 performed the action desired by the guest (e.g., the channel change). Operation 340 may cause the application on the mobile device 106 to update the mobile device 106 UI to reflect the action performed on the display 104 with one or more indications. In the channel change example, operation 340 may cause the indication of a channel change (or other indications) on the mobile device 106 to notify the guest that the display 104 performed the channel change.

In addition, the playback of content by the display 104 can be controlled by the mobile device 106. These operations can be continued until the mobile device 106 unpairs from the system or until the pairing relationship is otherwise terminated.

As may be appreciated, FIG. 3 relates to pairing a mobile device 106 with an SNC 116 to enable the mobile device 106 and upon pairing, the mobile device 106 controlling one or more aspects of a specific display 104. The same or similar concepts may be used to pair a mobile device 106 to an over-the-top (OTT) device which enables streaming and control of content to the display 104 through the paired OTT (e.g., a CHROMECAST). In one embodiment, successful pairing of a mobile device 106 to control a display 104 simultaneously enables control of an OTT. In addition, other suitable pairing methods may be performed that authorize a particular mobile device 106 to control a particular display 104 and/or OTT.

FIG. 4 illustrates a method 400 according to at least one example embodiment. The method 400 relates to generating and rendering customized ad content to a display 104 and/or mobile device 106.

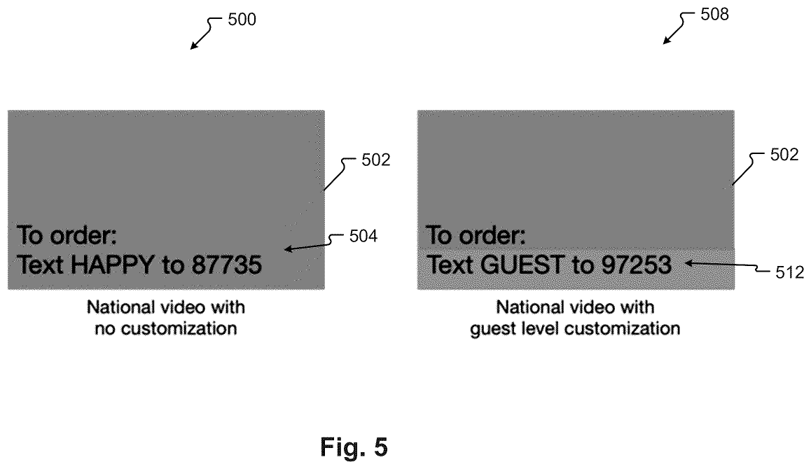

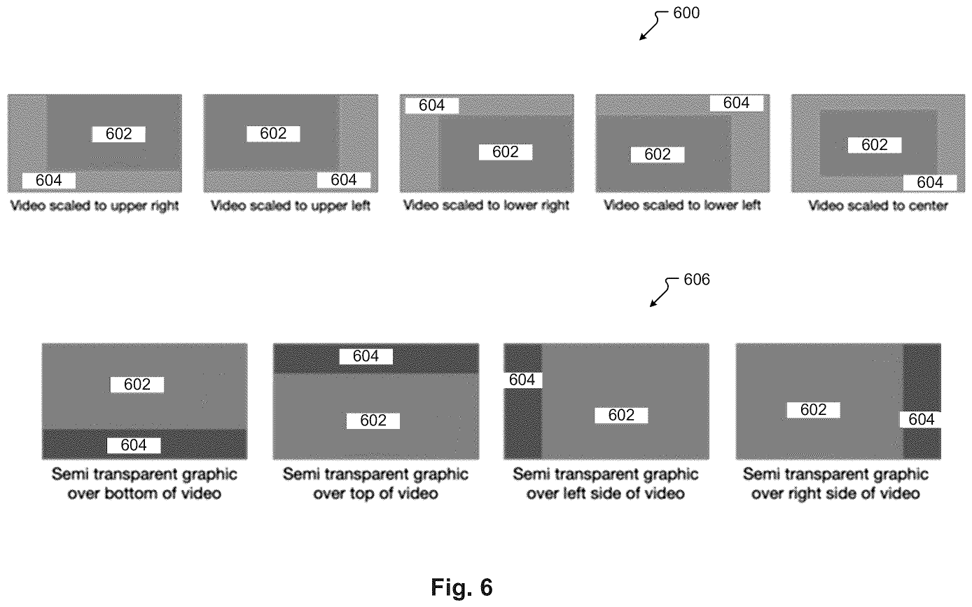

The steps in FIG. 4 may be carried out by one or more elements of the systems described herein, such as the SNC 116. The steps in FIG. 4 reference the ad content display examples in FIGS. 5 and 6. Accordingly, the method 400 is described with reference to FIGS. 1-3, 5, and 6.

The method 400 includes detecting a trigger event associated with a display 104 being viewed by a guest within a property 200. As may be appreciated from the discussion so far, the entertainment provider of a property 200 controls the television experience for guests, which includes things like channel lineups, interactive menu services, as well as video-on-demand (VOD) and other on-demand video streams. The entertainment provider may also control or provide the technology in the guestroom which enables manipulation of the content on an in-room TV in creative ways. Since one entity controls most or all of the TV experience, that entity can use a variety of triggers to start playing an ad or video content.

Thus, the trigger event in step 404 may be one of many possible trigger events that, upon detection, spawn customized ad generation for the guest or a group of guests. An instruction or other signal which is detected as a trigger event may be communicated to the SNC 116 through the various wired and/or wireless devices described as being located within a property 200, such as the display 104, mobile device 106, endpoint device 108, and/or router(s) 112. In some examples, the trigger event is detected by the SNC 116 upon receipt of an instruction or signal that corresponds to guest input to a remote control of the display 104 or to guest input to the mobile device 106. The input to the remote control or mobile device 106 may be a command for the display 104, the endpoint device 108, or the mobile device 106 to take a corresponding action. The instruction received by the SNC 116 may be an instruction to change channels, an instruction to tune to a particular channel, an instruction to retrieve on-demand content, an instruction to power off or on the display 104, an instruction to open a menu (e.g., an interactive program (IPG) menu, a static program menu), an instruction to exit a menu (e.g., an interactive program (IPG) menu, a static program menu), and/or any other suitable instruction that the entertainment provider or property 200 would like to use as a trigger to generate customized ad content. In some cases, the trigger event has an associated timing component. For example, a trigger event may be detected if the guest spends more than a threshold amount of time tuned to a particular channel or set of channels, if the guest spends more than a threshold amount of time viewing on-demand content, and/or if the guest takes a number of actions within a threshold amount of time (e.g., 20 channel changes within two minutes, which may indicate the guest is receptive to an ad directing the guest to engage in an alternative activity). In some examples, the trigger event is detected upon receiving a notification that on-demand content is beginning or ending.

In step 408, the method 400 includes generating, in response to the detecting the trigger event, ad content based on information about the guest that is available to the property 200. In general, step 408 includes determining which information (guest information, property information, or both) to use for generating ad content and then dynamically creating graphics and/or audio for ad content based on the information, and/or retrieving pre-existing graphics and/or audio for ad content based on the information. The ad content may then be rendered to a display 104 as standalone content or be incorporated into existing content for simultaneous rendering with the existing content.

In order to gather information useful for generating ad content, the SNC 116 may access internal storage or databases in one or more servers 124 to retrieve information about the guest which triggered the ad generation in step 404 and create audio and/or video containing ad content for sending to the display 104. Information about the guest that is also available to the property 200 and/or the property's entertainment provider includes information from property management systems (PMSs), reservation systems, loyalty programs, content management systems, and/or any other source which contains information about a guest that is accessible to the entertainment provider and/or property such that ad content provided to each guest is customized. Information about the guest may also be received or revealed by way of the pairing process described with reference to FIG. 3. Specific items of information about a guest may include name, phone number, loyalty number, viewing preferences (historical and/or dynamically set by the guest), viewing history (as collected by the entertainment provider over a series of visits to the same or different property), information related to the guest's past or planned activities at a property (the guest's indicated or historical preference to engage with hotel amenities and services, dining preferences), whether the guest is associated with a particular group of guests (a group attending a conference or a wedding), and/or any other information that is available to entertainment provider or property 200 and deemed useful for generating customized ad content.

In some examples, step 408 includes additionally or alternatively generating the ad content based on information about the property 200 retrieved by or stored at the SNC 116. Information about the property 200 which may prove relevant to generating the ad content includes contact information of the property 200 (address, phone number), contact information of other entities which partner with the property to provide guest services (address and phone number of nearby restaurants, casinos, providers of off-property excursions), brand of the property (e.g., hotel brand), manager of the property, and/or the like.

In general, generating the ad content may include augmenting existing content with dynamically created content or temporarily interrupting the existing content to replace the existing content with the ad content. In some cases, the existing content includes generic ad content which can be replaced, modified, or augmented. In other cases, the existing content does not include generic ad content, and thus, the generated ad content at step 408 is the only ad content within the eventual displayed content. These and other possibilities are discussed in more detail below.

As noted above, generating the ad content in step 408 may include augmenting generic ad content in existing content with dynamically created ad content. In some examples, the generic ad content is based on the information about the property and the dynamically created ad content is based on the information about the guest. For example, if the guest is a party to a wedding, and the generic ad may be for a service (e.g., a massage) offered by the property 200 but broadcast to multiple guests as a generic offer. Meanwhile, the dynamically created ad content may include content associated with the actual ad, such as a personalized QR code that links to a URL that preloads the guest's contact and room information into fields to enable convenient reservation of the service. The dynamically created content may additionally or alternatively include content which is not associated with the actual ad but that is customized to the guest or the property, such as icons that invoke the look and feel of the property, icons to invoke the look and feel of a wedding if the guest is a party to a wedding, or icons to invoke the look and feel of some other item or feeling that is personal to the guest. As may be appreciated, augmenting the generic ad content can include replacing or obscuring part of the generic ad content with the dynamically created content.

In some cases, the generic ad content is generic to all viewers (even off-property viewers) and the dynamically created content is based on information about the guest and/or information about the property (see FIG. 5). In this case, generating the ad content may include determining that the existing content contains ad information which is generic to off-property distribution of the existing content but that can be customized for a particular guest or a particular property, and then modifying the generic ad information so that the new ad content is customized to the particular guest and/or the particular property.

In some examples, generating the ad content includes augmenting existing content with the dynamically created ad content, where the existing content does not contain any ad information. Generating the ad content in step 408, then, includes augmenting the existing content with the dynamically created ad content in the same or similar manner as described with respect to generating ad content for existing content with generic ad content.

After ad generation in step 408, the ad content is rendered to the display 104 in step 412. For example, the SNC 116 may modify existing content (e.g., audio and/or video content that would otherwise be provided to the display absent the insertion of ad content) with ad content and send the resulting content to the display 104 or mobile device 106 through routers 112 and/or endpoint device 108. As described in more detail below with reference to FIGS. 5 and 6, modifying existing video content with ad content may include adjusting the existing video content to include the ad content and, if necessary, to format the resulting content for distribution within the property 200 to the display 104. Such formatting may include converting IP signals into RF signals for distribution to the display 104, creating a multicast transmission to send the resulting content to multiple guests within the property 200, and/or the like.

FIG. 5 illustrates example graphics to show how ad information in existing content may be customized for a particular guest or property.

Graphic 500 is an example of existing content 502 rendered to a display 104, where such existing content 502 includes generic ad information 504. Graphic 508, meanwhile, is an example of how the present disclosure may modify the existing content 502 to include customized ad content 512. In this case, step 408 determines that the generic ad information 504 can be replaced or augmented with customized ad information 512 to create an ad that can be traced back to property 200 or even the individual guest by way of changing the message and/or number for the guest to text. Thus, for graphic 508, step 408 generates an image, which could be non-interactive or interactive like a banner, with the customized ad information 512 (i.e., “Text GUEST to 97253”) and overlays the image on a portion of the existing content 502 which had the generic ad information in graphic 500 or scales down the existing content 502 to fit the image within a region vacated by the scaled existing content. As may be appreciated, some of the original generic ad content may remain in the graphic 508 (i.e., “To order:”). If the graphic 508 contains an interactive icon, such as a banner, selection of the interactive icon by the guest at the display 104 may spawn generation of additional content that provides the guest with more information about the selected icon. Such additional information may include additional dynamically generated ads that are customized for the guest and/or property.

Described another way, graphic 500 corresponds to a generic broadcast ad that has ordering information that everyone (even off-property viewers) would use to order an item. Generating ad content for the property 200, however, uses guest and/or property information generate the graphic 508 which overlays an image 512 onto the generic ad in order to make the fulfillment information specific to the property and/or guest.

FIG. 6 illustrates two example sets of graphics 600 and 606 which may be rendered to a display to show ad content along with existing content. In more detail, the graphics 600 show various examples for scaling existing video content 602 different areas of the display while simultaneously rendering ad content 604 to the regions of the display vacated by scaling the existing video. As shown, the existing video content may be scaled (e.g., downsized) in order to occupy the upper and lower right of a display, the upper and lower left of a display, or the center of the display such that the ad content 604 is adjacent to at least two sides of the scaled video content (four sides in the center scaling example). As may be appreciated, scaling the existing video content does not stretch the content along any of its axes, and thus, the existing video content appears as intended by its provider aside from scale.

Meanwhile the graphics 606 illustrate examples for overlaying images containing ad content 604 onto existing content 602 without scaling the existing content 602. In some cases, such as when the existing content is not already an ad or does not contain any generic ad information that could be modified, the overlaid images are semitransparent so as to not completely obscure the existing content in the background. In other cases, such as when the existing content is an ad that contains modifiable generic ad information, the overlaid image is opaque so as to block an irrelevant portion of the ad (as in FIG. 5). As may be appreciated, graphics 606 show that ad content appears at one edge of the existing content, however, example embodiments are not limited thereto, and the overlaid image or images may appear at two or more edges of the existing video content (as with graphics 600) or in any other portion of the existing video content.

In the examples shown and described with reference to FIGS. 5 and 6, it should be appreciated that audio content (if any) associated with the video ad content may replace the audio content for the existing video content. Although not explicitly shown, it should be appreciated that steps 408 and 412 may be performed such that modifying the existing content includes splicing the ad content into the existing content to temporarily interrupt and completely replace the existing content at the display 104 for some period of time before resuming the existing content at the point of interruption.

Step 416 may include the detecting a second trigger event associated with the display, with the detection of such a second trigger event causing cessation of the rendering of the ad content in step 420. For example, the SNC 116 receives an instruction or notification in the same or similar manner as described with reference to step 404, except that the instruction or notification that indicates to the SNC 116 that the ad content generated in step 408 should no longer be rendered to the display 104. The second trigger event may correspond to an instruction from the guest, by way of input to the remote control of the display 104 or to the mobile device 106, to exit the ad content as an explicit instruction, such as the guest selecting an “exit ad” or “skip ad” icon on the display 104. Exiting the ad content may also occur as a side effect of the guest commanding the display 104 or mobile device 106 to execute a different instruction, such as an instruction to change the channel or power off.

In any event, ceasing the rendering of ad content in step 420 may seamlessly return the guest to viewing the existing content without the ad content generated in step 408. For example, if the ad content is an overlay on existing content, the overlay may simply disappear to reveal the full picture of the existing content. If the existing content was scaled to make room for the ad content, the existing content may be returned to its original full-screen scale either all at once or gradually to provide an animation effect. In some cases, detecting the second trigger event may trigger further customized ad generation such that the method returns to step 408.

Inventive concepts propose to address technical problems in the field by providing properties and entertainment providers with the ability to present customized and personalized ads to guests within the property using existing information about the property and the guests.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A system, comprising:
a processor; and
memory including instructions, that when executed by the processor, cause the processor to:
detect a trigger event associated with a display being viewed by a guest within a property;
generate, in response to the detecting the trigger event, ad content based on information about the guest that is available to the property; and
render the ad content to the display.

2. The system of claim 1, wherein rendering the ad content includes overlaying the ad content onto existing content and rendering the existing content along with the overlaid ad content to the display.

3. The system of claim 2, wherein the overlaid ad content is semitransparent.

4. The system of claim 2, wherein the ad content is overlaid onto the existing content at an edge of the existing content.

5. The system of claim 1, wherein rendering the ad content to the display includes downsizing existing content and rendering the downsized existing content along with the ad content to the display.

6. The system of claim 5, wherein the ad content frames at least two sides of the downsized existing content.

7. The system of claim 1, wherein rendering the ad content includes temporarily interrupting and replacing existing content with the ad content.

8. The system of claim 1, wherein the trigger event is at least one of the following:
an instruction to change channels;
an instruction to tune to a particular channel;
an amount of time spent tuned to a particular channel;
an instruction to retrieve on-demand content;
an amount of time spent viewing on-demand content;
a notification that on-demand content is beginning or ending;
an instruction to power off or on the display;
an instruction to open a menu; or
an instruction to exit a menu.

9. The system of claim 1, wherein generating the ad content includes dynamically creating ad content based on the information about the guest.

10. The system of claim 9, wherein generating the ad content includes augmenting generic ad content with the dynamically created ad content.

11. The system of claim 1, wherein generating the ad content is further based on information about the property.

12. The system of claim 1, wherein the information about the guest includes information about a group of guests to which the guest is known belong.

13. The system of claim 1, further comprising:
a first communication interface to communicate with a network of the property; and
a second communication interface to communicate with a network outside of the property.

14. A device, comprising:
a processor; and
memory including instructions, that when executed by the processor, cause the processor to:
detect a trigger event associated with a display being viewed by a guest within a property;
generate, in response to the detecting the trigger event, ad content based on information about the property and information about the guest that is available to the property; and
render the ad content to the display.

15. The device of claim 14, wherein generating the ad content includes dynamically creating ad content.

16. The device of claim 15, wherein generating the ad content includes augmenting generic ad content with the dynamically created ad content.

17. The device of claim 16, wherein the generic ad content is based on the information about the property and the dynamically created ad content is based on the information about the guest.

18. The device of claim 16, wherein augmenting the generic ad content includes replacing part of the generic ad content with the dynamically created content.

19. The device of claim 14, wherein the information about the guest includes information about a group of guests to which the guest is known belong.

20. A method, comprising:
detecting a trigger event associated with a display being viewed by a guest within a property;
generating, in response to the detecting the trigger event, ad content based on information about the guest that is available to the property; and
rendering the ad content to the display.
